(19) United States
(12) Patent Application Publication
(10) Pub. No.: US 2007/0027959 A1
(43) Pub. Date: Feb. 1, 2007

(54) Virtual memory remote control

(75) Inventors: Glen Harris, Auckland (NZ); Maxim Vlassov, Geneva (CH); Eric Raeber, Redwood City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/408,677

(22) Filed: Apr. 21, 2006

Related U.S. Application Data
(60) Provisional application No. 60/673,849, filed on Apr. 22, 2005.

(51) Int. Cl. G06F 15/16

(52) U.S. Cl. 709/217

(57) ABSTRACT

A remote control system includes a remote control that includes a first memory configured to store remote-control information, and a display for displaying the remote-control information; and a computer having a second memory that the remote control is configured to access via a wireless communication link, wherein the second memory is configured as a virtual memory for the remote control and is configured to store portions of the remote-control information.

### CROSS-REFERENCES TO RELATED APPLICATIONS

This application is related to and claims priority from U.S. Provisional Application No. 60/673,849, filed Apr. 22, 2005, titled “Virtual Memory Remote Control,” and is fully incorporated herein by reference for all purposes.

### BACKGROUND OF THE INVENTION

The present invention generally relates to remote control systems, and more particularly relates to a remote control configured to use a remote virtual memory.

Remote controls are ubiquitously used to control electronic devices. For example, modern remote controls are configured to control not only entertainment systems, but are configured to control computers, environmental control devices and the like. Moreover, these remote controls are often configured to control the interactions of electronic devices.

While a large variety of remote controls are available to consumers for controlling electronic devices, the remote control industry continues to strive to develop new remote controls that offer new remote control features.

### BRIEF SUMMARY OF THE INVENTION

The present invention provides a remote control system the includes a remote control that includes a first memory configured to store remote-control information, and a display for displaying the remote-control information. The remote control system further includes a computer having a second memory that the remote control is configured to access via a wireless communication link. The second memory is configured as a virtual memory for the remote control and is configured to store portions of the remote-control information that do not fit in the first memory. The remote control is configured to retrieve the portions of the remote-control information from the computer as the remote control is requested by a user to display this portion of the information on the remote control's display. The computer may anticipate the remote control's use of the remote-control information in the virtual memory and transfer one or more portions of this information to the first memory.

According to a specific embodiment, the computer is configured to identify items of the remote-control information stored in the second memory for transfer to the first memory for accelerated scrolling through the remote-control information on the display. According to another specific embodiment, the communication link is a Bluetooth link.

According to another specific embodiment, the remote control is configured to transfer to the computer information for a memory navigation rate of the first memory, and the computer is configured to direct the remote control to enter an accelerated scrolling mode based on the memory navigation rate. The computer is configured to direct the remote control to enter the accelerated scrolling mode if the memory navigation rate is above a threshold memory navigation rate.

According to another specific embodiment, the remote control includes a wheel and/or a set of control buttons, the remote control is configured to transfer to the computer information for one or more of a rotation rate of the wheel and/or a length of time a given one of the control buttons is pressed, and the computer is configured to direct the remote control to enter an accelerated scrolling mode based on the rotation rate and/or the length of time.

According to another embodiment, a remote control is provided that includes a memory configured to store remote-control information; a display configured to display the remote-control information; a wheel configured to be rotated to initiate scrolling of the remote-control information on the display; and a transceiver configured to transfer to a computer a navigation rate of the memory and/or a rotation rate of the wheel, and to receive a command from the computer to display the remote-control information in a sequential scrolling mode or in an accelerated scrolling mode based on the navigation rate and/or the rotation rate. The computer is configured to store a portion of the remote-control information, and the transceiver if configured to request and receive the portion of remote-control information from the computer. The transceiver is configured to receive from the computer nearest neighbor data items from the portion of remote-control information if the remote control is in the sequential scrolling mode. The transceiver is configured to receive from the computer far neighbor data items from the portion of remote-control information if the remote control is in the accelerated scrolling mode. Nearest neighbor data items are sequential data items in the memory and/or the computer, and the far neighbor data items are separated in the memory and/or the computer by one or more other data items. According to a specific embodiment, the remote control further includes a processor that is configured to transition the remote control from the accelerated scrolling mode to sequential scrolling mode based on the navigation rate of the memory and/or the rotation rate of the wheel.

According to another embodiment, a computer is provided that includes a memory configured to store remote-control information; and a computer transceiver configured to transfer at least of portion of the remote-control information to a remote control device. The remote control device includes: i) a display configured to display the remote-control information, ii) a wheel configured to be rotated to initiate scrolling of the remote-control information on the display, and iii) a remote-control transceiver configured to transfer to the computer transceiver a navigation rate of the memory and/or a rotation rate of the wheel, and to receive a command from the computer transceiver to display the remote-control information in a sequential scrolling mode or in an accelerated scrolling mode based on the navigation rate and/or the rotation rate. The computer may further include a processor that is configured to determine whether the navigation rate is above a threshold navigation rate and to determine whether the rotation rate is above a threshold rotation rate.

A further understanding of the nature and advantages of the present invention may be realized by reference to the remaining portions of the specification and the drawings.

### BRIEF DESCRIPTION OF THE DRAWINGS

FIG. 1 is a simplified schematic of a remote control system having a remote control and a computer that includes a memory configured for use by the remote control as a virtual memory;

FIG. 2 is a simplified schematic of the remote control system showing electronic modules included in the remote control including the remote control's processor, Bluetooth module, remote control memory, display controller, and transceiver;

FIG. 3 is a simplified schematic of a remote control system according to another embodiment wherein the remote control includes a roller configured to up, down, left, and right scrolling of data items displayed on the remote control's display; and

FIG. 4 is a simplified schematic of a remote control system according to another embodiment wherein the remote control includes a scroll wheel configured to rotated scroll data items displayed on the remote control's display.

### DETAILED DESCRIPTION OF THE INVENTION

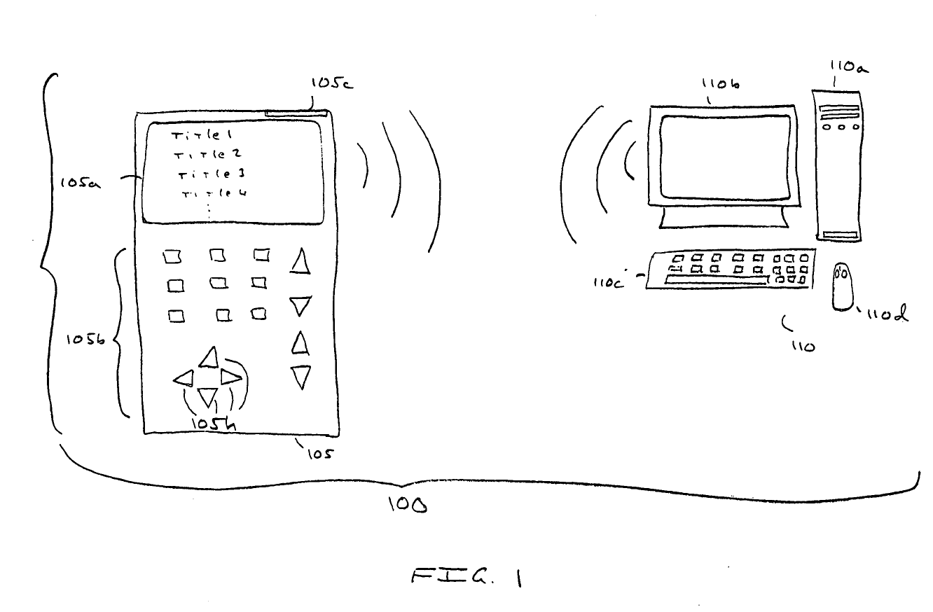

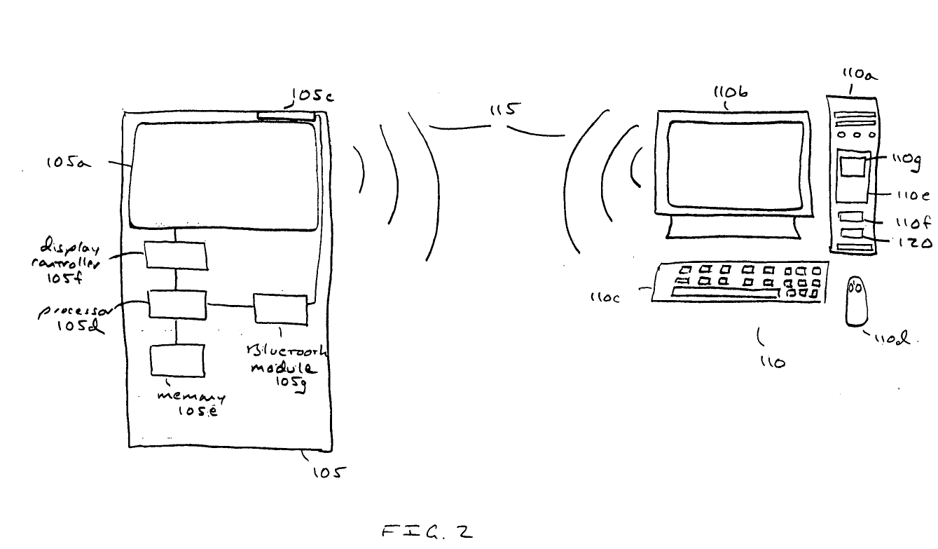

FIG. 1 is a simplified schematic of a remote control system 100 according to one embodiment of the present invention. System 100 includes a remote control 105 and a computer system 110. Remote control 105 may include a display 105a, a set of control keys 105b (the keys may be incorporated in the display), and at least one transceiver 105c. As shown in FIG. 2, the remote control may also include a processor 105d (e.g., a microprocessor, a microcontroller or the like), a memory 105e, a display controller 105f, and a wireless communication controller 105g, such as a Bluetooth module. Computer system 110 may include a computer 110a, a monitor 110b, and one or more input devices, such as a keyboard 110c, a mouse 110d or the like. Computer 110a may include a memory 110e, a transceiver 110f that is configured to communicate with the remote control via transceiver 105c.

Transceivers 105c and 110f may be configured to communicate via a communication link 115 that communicatively couples the remote control and the computer. The transceivers may be infrared (IR) transceivers, radio frequency (RF) transceivers, ultrasonic transceivers, light based transceivers, a combination of the foregoing or the like. The transceivers may be configured to operate according to one or more communication protocols, such as the Bluetooth protocol, the Home RF protocol, a network protocol (e.g., WiFi) or the like.

The display of the remote control, which may be back lighted, is configured to display a variety of remote-control information, such as navigation menus, bitmaps, font tables, text strings (e.g., play lists of music titles, video titles, television programs, etc.) and the like. The remote-control information may be relatively large and may exceed the memory capacity of remote control memory 105e.

According to one embodiment, the remote control is configured to use a portion 110g of computer memory 110e of computer 110a as a virtual memory. Remote-control information that exceeds (or overflows) the memory capacity of the remote control memory may be stored in the virtual memory. The remote control may be configured to access the virtual memory via a communication link 115. The remote control memory and/or the virtual memory may organize the remote-control information in pages or the like. The remote control may be configured to retrieve remote-control information from the virtual memory via the communication link for display on the display. Alternatively, the computer may be configured to initiate transfer of the remote-control information to the remote control. This transfer of information initiated by the computer to the remote control is often referred to as pushing information, whereas the retrieval of information initiated by the remote control is often referred to as pulling information. The remote-control information may be pushed or pulled before or as the user scrolls through the remote-control information displayed on display 105a.

According to one embodiment, a software module 120 configured to operate on computer 105a is configured to build virtual memory 110g (e.g., about a 16 megabyte memory block). Virtual memory 110g may be organized as a set of memory blocks. Each memory block may include 256 bytes or the like. The virtual memory may be configured to store the remote-control information, such as navigation menus, bitmaps (e.g., icons), font tables, text strings (e.g., play lists of music titles, video titles, television programs, etc) and the like. According to one embodiment, the memory blocks are prioritized such that a memory block that includes a font table has the highest priority, whereas a submenu (e.g., “third level submenu”) or the like has the lowest priority. Such prioritization provides that a virtual memory manager operating on the computer may transfer to the remote control or swap relatively less useful pages with relatively more useful pages if the remote control needs more remote control memory freed (i.e., needs to use more of the virtual memory).

The computer and the remote control may be configured to communicate via atomic functions that allow memory changes and event notifications. The atomic functions are aggregated into transport packets that are configured according to the particular transport layer over which the packets are transported. According to one embodiment, the transport packets are sent via 17 or 64 byte packets over a Bluetooth link.

Traditional techniques for scrolling through information on a remote control typically include accessing a complete data file (e.g., a full list of data items) that is stored in local memory. Typically a user action of the scrolling device (e.g., a set of scroll buttons, a scroll wheel, etc.) provides scrolling of one data item per scroll event (e.g., scroll wheel “click”). If accelerated scrolling is activated, traditional acceleration techniques include skipping a select number of data items to display one or more data items higher or lower in a list of data items.

As described briefly above, and according to embodiments of the present invention, all data items for the remote-control information may not be located in the remote control memory. A portion of the data items may be stored in the virtual memory in the computer. These data items may not be sequential. A menu list of the data items stored in the virtual memory may be built in the virtual memory by software module 120 (e.g., remote control software) running on the computer. A menu list may include a list of information that identifies the data items in the virtual memory. For example, a menu list may include a list of song titles or the names of musicians for a group of data items that might include songs or the like that are respectively associated with the song titles or musicians.

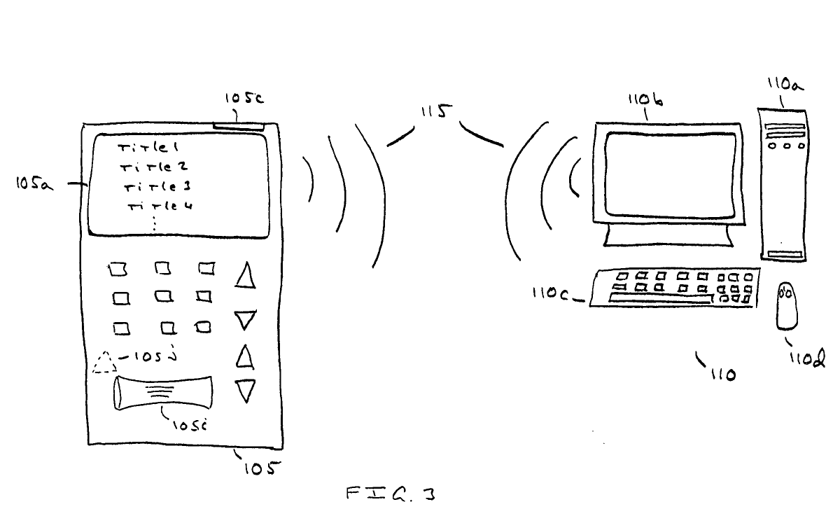

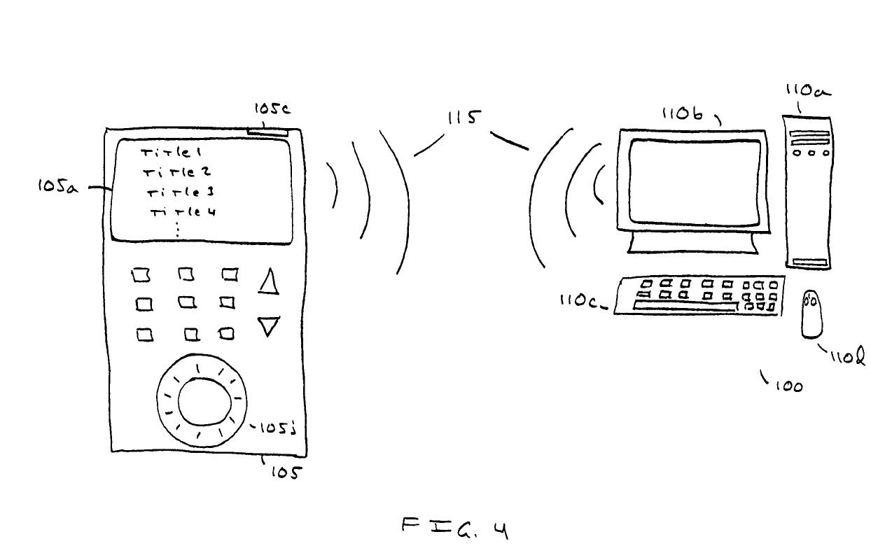

According to one embodiment, the remote control may be configured to provide vertical and/or horizontal scrolling of the remote-control information displayed on display 105a. Scrolling may be controlled via a set of control buttons 105h, a roller 105i (see FIG. 3), a combination of a control button 105h (shown in phantom in FIG. 3) and roller 105i, a scroll wheel 105j (see FIG. 4) or the like.

The set of control buttons 105h might include four buttons for scrolling up, down, left, and right. These control buttons might alternatively be configured for selecting items from a menu and/or exiting a menu. The control buttons might be configured to provide accelerated scrolling through the remote-control information if, for example, the buttons are pressed longer than a select amount of time (e.g., two seconds), are pressed with a force greater than a select amount of force or the like.

The roller may be configured to roll up and down for vertical scrolling and tilt left and right for left and right scrolling, respectively. The roller may provide for accelerated scrolling if the roller is rotated at a rate higher than a select rate, and/or rotated (e.g., substantially continuously) for longer than a select amount of time (e.g., 1 second). The roller might alternatively be configured to provide accelerated scrolling if the roller is rotated as an acceleration button 105j is pressed. According to one embodiment, roller 105i is configured to operate as a “jog dial” that provides accelerated scrolling as the roller is rotated further from a neutral position.

The scroll wheel may be configured to be rotated left or rotated right to vertically scroll the remote-control information. The scroll wheel might be a configured to operate as a jog dial or might be configured for continuous rotation. The scroll wheel might be configured to tilted left and right for left and right scrolling, respectively. The scroll wheel may provide for accelerated scrolling if the scroll wheel is rotated at a rate higher than a select rate, and/or rotated (e.g., substantially continuously) for longer than a select amount of time (e.g., 1 second). The scroll wheel may be configured to be pressed to make a selection of a data item. The foregoing are merely exemplary embodiments of accelerated scrolling and should not be viewed as limiting the invention as defined by the claims.

According to one embodiment, the computer is configured to control accelerated scrolling of the remote-control information displayed on the remote control. The remote control may be configured to transfer to the computer the rate at which the remote-control information is being displayed on the remote control display (i.e., the rate at which the remote control memory is being navigated), the rate of rotation of the roller, the rate of rotation of the scroll wheel or the like. The computer may be configured to determine whether one or more of these rates is above a threshold rate and direct the remote control to execute accelerated scrolling. For example, the computer may provide the remote control the remote-control information to effect accelerated scrolling.

For example, the remote-control information may be organized as a list of information in computer memory 110g and in remote control memory 105e. In a sequential scrolling mode, nearest neighbor data items (e.g., menu items for a list of songs or the like) in the remote-control information may be sequentially displayed on the remote control display. In an accelerated scrolling mode, “far neighbor” data items may be sequentially displayed. Far neighbor data items are separated from one another in the list of remote-control information by one or more data items. For example, the far neighbor data items may be separated from one another by one or more memory address identifiers.

As described briefly above, the computer may effect accelerated scrolling based on the scrolling rate of the remote-control information displayed on the display, the memory navigation rate of the remote control, the rotation of the roller wheel, scroll wheel or the like, the lengths of time one or more of the scrolling buttons is pressed or the like. These rates and/or periods may be supplied to the computer by the remote control a regular intervals. If one or more of these rates and/or periods is at or below a threshold level, the computer may send to the remote control a sequence of nearest neighbor data items. If one or more of these rates and/or periods is above a threshold level, the computer may send to the remote control a sequence of far neighbor data items. The remote control may be configured to store this sequence of far neighbor data times in the remote control memory, and sequentially display these far neighbor data items.

According to one embodiment, the number of data items between far neighbor data items is predetermined. The remote control and/or the computer may have a memory pointer that “jumps” through the computer memory sequentially or by the predetermined number of data items to control sequential scrolling and accelerated scrolling. The computer may control accelerated scrolling in the remote control by transferring to the remote control a sequence of far neighbor data items separated by the predetermined number of data items.

According to an alternative embodiment, the number of data items between far neighbor data items may be dynamically determined by the computer. For example, the number data items may be determined based on the above described scrolling rates, memory navigation rates, the rotation rates, the length of time a scrolling button is pressed or the like. The number of data items between far neighbor data items may be larger for a first rate of data navigation, scrolling or the like that is higher than another rate of data navigation, scrolling or the like. The number of data items between far neighbor data items may be smaller for a first rate of data navigation, scrolling or the like that is less than another rate of data navigation, scrolling or the like. Alternatively, the number of data items separating far neighbor data items may be based on a ratio of the total number of data items in a menu list and/or the number of data items in the remote control memory, or otherwise based on the total number of data items in the group of data items, wherein the group of data items may be stored in both the remote control memory and the virtual memory. The computer may have a memory pointer that jumps through the computer memory sequentially or by the dynamically determined number of data items to control sequential scrolling and accelerated scrolling. The computer may control accelerated scrolling in the remote control by transferring to the remote control a sequence of far neighbor data items separated by the dynamically determined number of data items.

According to another embodiment, the remote control and/or the computer is configured to generate and store a pair of pointers for each data item. The first pointer, or nearest neighbor pointer, for a given data item may point to a nearest neighbor data item. The second pointer, or far neighbor pointer, for the given data item may point to a far neighbor data item. The number of data items separating the given data item and the far neighbor data item may be a fixed number, may be dynamically determined as described above. For sequential scrolling, the remote control may use nearest neighbor pointers to present a sequence of data items on the remote control display. For accelerated scrolling, the remote control may use far neighbor pointers to present a sequence of far neighbor data items on the remote control display. The computer may similarly use such pairs of pointers track and retrieve data items in the virtual memory and to transfer these data items to the remote control to effect sequential or accelerated scrolling.

According to one embodiment, the computer is configured to identify the far neighbor data items pointed at by the second pointer, and transfer the identity of the far neighbor data item to the remote control. The far neighbor data item may be in the remote control's local memory, or might be in the virtual memory and might be transferred to the remote control via the data link. As the computer determines the far neighbor data items for display in the acceleration mode, the processing power (e.g., acceleration calculations, data lookup, etc.) of the remote control may be lowered. According to a further embodiment, the computer defines the acceleration factor (e.g., the number of scrolled lines). The acceleration factor may increment lines linear, exponentially, proportional to a percentage of the number of items in the list or the like. If the computer tracks a currently highlighted data item displayed on the display of the remote control, the computer can determine the scrolling speed, adapt the acceleration dynamically and determine the appropriate far neighbor data item for each data item in the portion of the menu list loaded into remote control memory 105e.

The computer is configured to determine each far neighbor data item that is pointed at by each second pointer for each data item stored in the remote control memory. The computer may transfer to the remote control memory the upcoming far neighbor menu determined by the computer. As the remote control memory may include the far neighbor data items, the latency for displaying these far neighbor data items during accelerated scrolling may be relatively small. Moreover, as the computer is configured to determine these far neighbor data items, and transfer these far neighbor data items to the remote control, other intermediary data items between far neighbor data items may not be transferred to the remote control providing for relatively high efficiency remote control memory management.

The transition from accelerated scrolling to sequential scrolling and/or stopping scrolling may be determined by the remote control or the computer. For example, the remote control may be configured to track the variously described factors for entering accelerated scrolling mode, and if these conditions for accelerated scrolling stop, the remote control may display nearest neighbor data items in a sequential manner. Alternatively, the computer may be configured to track the variously described factors for entering accelerated scrolling mode, and if the conditions described above for accelerated scrolling stop, the computer may direct the remote control to enter sequential scrolling mode by sending sequential nearest neighbor data items to the remote control for display.

According to one embodiment, the computer transceiver may be a dongle that is configured to be coupled to the computer, for example, coupled to the computer via one of the computer's universal serial bus ports. The remote control and the dongle may be “paired” devices, such as paired Bluetooth devices. These devices may be paired by a radio frequency identification (RFID) tag for the like. For a further understanding of paring devices via RFID tags, see U.S. patent application Ser. No. 10/950,361, filed Nov. 23, 2004, and titled “RFID Auto-Connect For Wireless Devices,” which is incorporated by reference herein in its entirety.

According to one embodiment, the remote-control information is hierarchical. Menu items and/or data items (e.g., higher level data items) may be associated with other menu items and/or data items (e.g., lower level data items). For example, the names of music genres, video genres, book genres or the like may be included in higher level data items, and may be associated with lower level data items that might include musician information, album names, music track names or the like. These lower level data items might be associated with submenu data items that are “below” the lower level data items. The submenu data items might include one or more command codes for controlling one or more electronic devices to play a given music track, video track, electronic book or the like.

Lower level data items may be selected by the computer via the selection of a higher level data item by a user using the remote control. The computer is configured to determine from a pointer or the like for a higher level data item, the lower level data item that is associated with the higher level data item. The computer may also be configured to determine from a given lower level data item, a higher level data item associated with the given lower level data item.

According to one embodiment, if a higher level data item is selected via the remote control by a user for use, the computer is configured to determine and transfer to the remote control the lower level data items associated with the higher level data item. The higher level data item may be displayed on the display of the remote control and the user may select the higher level data item by pressing a given control button, pressing the roller, pressing the wheel or the like. The remote control may thereafter be configured to transfer to the computer information for the higher level data item selected by the user. The computer may then determine the lower level data item that is associated with the selected higher level data item. The computer may then be configured to load the lower level data items to the remote control for the selected higher level data items. Alternatively, the remote control may transfer to the computer all of the higher level data items displayed on the display, and the computer may in turn transfer to the remote control all of the lower level data items associated with the higher level data items displayed on the display. Therefore, the lower level data items will be in the remote control before the user selects a higher level data item thereby reducing latency once a higher level data item is selected.

According to one embodiment, a number of lower level data items might be associated with a higher level data item. For a displayed higher level data item, the computer might be configured to transfer to the remote control all or a portion of the lower level data items associated with the displayed higher level data item. The remote control may also transfer to the computer information for lower level data items that are and/or are not already resident in the remote control memory, and the computer may transfer to the remote control those lower level data items that are not resident in the remote control memory.

According to yet another embodiment, the computer may be configured to transfer to the remote control various data items in the lower level data items for higher level data items that are in the remote control. The computer may transfer these lower level data items to the remote control regardless of whether the higher level data items have been displayed on the display. The transfer of lower level data items by the computer to the remote control prior to the selection of a higher level data item by the user is generally referred to herein a prefetching the lower level data items. The computer may prefetch data items for both the sequential scrolling mode and the accelerated scrolling mode. Prefetch generally reduces the latency period for the remote control to control an electronic device (e.g., CD player, TV, etc.). Those of skill in the art will know of a variety of database management techniques for associating higher level data items with lower level data items and as such, these associations will not be described in detail herein.

Computer programs incorporating various features of the present invention may be encoded on various computer readable media for storage and/or transmission; suitable media include magnetic disk or tape, optical storage media such as CD or DVD, flash memory, and carrier signals adapted for transmission via wired, optical, and/or wireless networks conforming to a variety of protocols, including the Internet. Computer readable media encoded with the program code may be packaged with a compatible device or provided separately from other devices (e.g., via Internet download).

While the present invention has been described with reference to specific hardware and software components, those skilled in the art will appreciate that different combinations of hardware and/or software components may also be used, and that particular operations described as being implemented in hardware might also be implemented in software or vice versa. For example, the remote control may be a rechargeable device. Therefore, it is to be understood that the examples and embodiments described above are for illustrative purposes only and that various modifications or changes in light thereof will be suggested to persons skilled in the art and are to be included within the spirit and purview of this application and scope of the appended claims. Therefore, the above description should not be taken as limiting the scope of the invention as defined by the claims.

What is claimed is:

1. A remote control system comprising:
a remote control that includes a first memory configured to store remote-control information, and a display for displaying the remote-control information; and
a computer having a second memory that the remote control is configured to access via a wireless communication link, wherein the second memory is configured as a virtual memory for the remote control and is configured to store portions of the remote-control information.

2. The remote control system of claim 1, wherein the computer is configured to identify data items from the remote-control information stored in the second memory for transfer to the first memory for accelerated scrolling through the remote-control information on the display.

3. The remote control system of claim 2, wherein the wireless communication link is a Bluetooth link.

4. The remote control system of claim 1, wherein the remote-control information includes a plurality of level of data items, wherein the computer is configured to the remote control all or a portion of data items associated with remote-control information displayed on the display.

5. The remote control system of claim 4, wherein prior to transfer of data items from the computer to the remote control, these data items are not in the first memory.

6. The remote control system of claim 1, wherein the virtual memory is configured to store a portion of the remote-control information that overflows from the first memory.

7. The remote control system of claim 1, wherein the remote control and/or the computer are configured to determine for each data item in the remote control a neighbor data item whose distance to a previous data item is based on an acceleration function.

8. The remote control system of claim 1, wherein the remote control and/or the computer are configured to transfer to the computer information for a memory navigation rate of the first memory, and the computer is configured to direct the remote control to enter an accelerated scrolling mode based on the memory navigation rate.

9. The remote control system of claim 8, wherein the computer is configured to direct the remote control to enter the accelerated scrolling mode if the memory navigation rate is above a threshold memory navigation rate.

10. The remote control system of claim 8, wherein the remote control and/or the computer are configured to determine for each data item in the remote-control information a nearest neighbor data item and a far neighbor data item.

11. The remote control system of claim 10, wherein:
for a sequential scrolling mode of the remote control, the computer is configured to direct the remote control to display nearest neighbor data items as the remote-control information is scrolled on the display, and
for the accelerated scrolling mode, the computer is configured to direct the remote control to display far neighbor data items as the remote-control information is scrolled on the display.

12. The remote control system of claim 8, wherein the remote control and/or the computer are configured to determine for each data item in the remote-control information a far neighbor data item.

13. The remote control system of claim 11, wherein nearest neighbor data items are sequential data items in the first memory and/or the virtual memory, and far neighbor data items are separated in the first memory and/or the virtual memory by one or more other data items.

14. The remote control system of claim 11, wherein:
for a sequential scrolling mode of the remote control, the computer is configured to transfer to the remote control nearest neighbor data items as the remote-control information is scrolled on the display, and
for the accelerated scrolling mode, the computer is configured to transfer to the remote control far neighbor data items as the remote-control information is scrolled on the display.

15. The remote control system of claim 1, wherein:
the remote control includes a wheel and/or a set of control buttons,
the remote control is configured to transfer to the computer information for one or more of a rotation rate of the wheel and/or a length of time a given one of the control buttons is pressed, and
the computer is configured to direct the remote control to enter an accelerated scrolling mode based on the rotation rate and/or the length of time.

16. The remote control system of claim 15, wherein the remote control and/or the computer are configured to determine for each data item in the remote-control information a nearest neighbor data item and a far neighbor data item.

17. The remote control system of claim 16, wherein nearest neighbor data items are sequential data items in the first memory and/or the virtual memory, and far neighbor data items are separated in the first memory and/or the virtual memory by one or more other data items.

18. The remote control system of claim 15, wherein:
for a sequential scrolling mode of the remote control, the computer is configured to direct the remote control to display nearest neighbor data items as the remote-control information is scrolled on the display, and
for the accelerated scrolling mode, the computer is configured to direct the remote control to display far neighbor data items as the remote-control information is scrolled on the display.

19. The remote control system of claim 18, wherein:
for the sequential scrolling mode, the computer is configured to transfer to the remote control nearest neighbor data items as the remote-control information is scrolled on the display, and
for the accelerated scrolling mode, the computer is configured to transfer to the remote control far neighbor data items as the remote-control information is scrolled on the display.

20. A remote control comprising:
a memory configured to store remote-control information;
a display configured to display the remote-control information;
a wheel configured to be rotated to initiate scrolling of the remote-control information on the display; and
a transceiver configured to transfer to a computer a navigation rate of the memory and/or a rotation rate of the wheel, and to receive a command from the computer to display the remote-control information in a sequential scrolling mode or in an accelerated scrolling mode based on the navigation rate and/or the rotation rate.

21. The remote control of claim 20, wherein the computer is configured to store a portion of the remote-control information, and the transceiver if configured to request and receive the portion of remote-control information from the computer.

22. The remote control of claim 20, wherein the computer is configured to store a portion of the remote-control information and transfer the portion of the remote-control information to the transceiver.

23. The remote control of claim 20, wherein:
the computer is configured to store a portion of the remote-control information,
the transceiver is configured to receive from the computer nearest neighbor data items from the portion of remote-control information if the remote control is in the sequential scrolling mode, and
the transceiver is configured to receive from the computer far neighbor data items from the portion of remote-control information if the remote control is in the accelerated scrolling mode.

24. The remote control of claim 23, wherein the nearest neighbor data items are sequential data items in the memory and/or the computer, and the far neighbor data items are separated in the memory and/or the computer by one or more other data items.

25. The remote control of claim 23, wherein the display is configured to display data items received from the computer.

26. The remote control of claim 20, wherein the remote control further includes a processor that is configured to transition the remote control from the accelerated scrolling mode to sequential scrolling mode based on the navigation rate of the memory and/or the rotation rate of the wheel.

27. A computer comprising:
a memory configured to store remote-control information; and
a computer transceiver configured to transfer at least a portion of the remote-control information to a remote control device;
wherein the remote control device includes:
a display configured to display the remote-control information,
a wheel configured to be rotated to initiate scrolling of the remote-control information on the display, and
a remote-control transceiver configured to transfer to the computer transceiver a navigation rate of the memory and/or a rotation rate of the wheel, and to receive a command from the computer transceiver to display the remote-control information in a sequential scrolling mode or in an accelerated scrolling mode based on the navigation rate and/or the rotation rate.

28. The computer of claim 27, further comprising a processor that is configured to determine whether the navigation rate is above a threshold navigation rate and to determine whether the rotation rate is above a threshold rotation rate.

29. A remote control system comprising:
a remote control that includes a first memory configured to store remote-control information, and a display for displaying a first level of data items for a set of remote-control information; and
a computer having a second memory that the remote control is configured to access via a wireless communication link,
the second memory is configured as a virtual memory for the remote control and is configured to store portions of the remote-control information, and
the computer is configured to transfer to the remote control a second level of data items associated with the first level of data items.

30. The remote control system of claim 29, wherein the first level of data items are higher level data items and the second level of data items are lower level data items.

31. The remote control system of claim 29, wherein the second level of data items are a subset of data items associated with the first level of data items.

32. A remote control system comprising:
a remote control that includes a first memory configured to store remote-control information, and a display for displaying a first level of data items for a set of remote-control information; and
a computer having a second memory that the remote control is configured to access via a wireless communication link,
the second memory is configured as a virtual memory for the remote control and is configured to store portions of the remote-control information, and
the computer is configured to transfer at least one second level data item associated with a given one of first level of data items to the remote control, if the given one of the first level data items is selected by a user.

33. The remote control system of claim 32, wherein the first level of data items are higher level data items and the second level of data items are lower level data items.

34. The remote control system of claim 32, wherein one or more of the first level data items is respectively associated with a set of data items, and the computer is configured to transfer to the remote control one or more data items from the set of data items for the given one of the first level data items.
